(19) United States
(12) Patent Application Publication
(10) Pub. No.: US 2022/0179402 A1
(43) Pub. Date: Jun. 9, 2022

(54) METHOD AND DEVICE FOR ANALYZING A SEQUENTIAL PROCESS

(71) Applicant: WAGO Verwaltungsgesellschaft mbH, Minden (DE)

(72) Inventors: Nikolai FALKE, Porta Westfalica (DE); Jan JENKE, Bad Oeynhausen (DE); Thomas HOLM, Rinteln (DE); Calvin Darian WOLTING, Raddestorf (DE)

(73) Assignee: WAGO Verwaltungsgesellschaft mbH, Minden (DE)

(21) Appl. No.: 17/682,845

(22) Filed: Feb. 28, 2022

Related U.S. Application Data
(63) Continuation of application No. PCT/EP2020/074138, filed on Aug. 28, 2020.

(30) Foreign Application Priority Data
Aug. 29, 2019 (DE) 10 2019 213 019.4

(51) Int. Cl. G05B 19/418

(52) U.S. Cl. CPC G05B 19/4184; G05B 2219/32201

(57) ABSTRACT

A device and method for analyzing a sequential process, the sequential process including at least one repeating subprocess, and the method comprising the following steps: Recording process data of the sequential process over a reference time period; Automatically determining phase limits, based on the recorded process data; Identifying at least one repeating subprocess, the duration of which is limited in time by two adjacent phase limits; Determining at least one reference variable for each identified repeating subprocess from the process data recorded in the time period; Recording process data of the sequential process over a time period following the reference time period, and repeating steps b. and c. for the purpose of detecting the recurrence of an identified subprocess; Comparing the recorded process data of the detected subprocess with the at least one reference variable of the corresponding identified subprocess to establish deviations from a normal operation.

This nonprovisional application is a continuation of International Application No. PCT/EP2020/074138, which was filed on Aug. 28, 2020, and which claims priority to German Patent Application No. 10 2019 213 019.4, which was filed in Germany on Aug. 29, 2019, and which are both herein incorporated by reference.

### BACKGROUND OF THE INVENTION

### Field of the Invention

The present invention relates to a method and a device for analyzing a sequential process, in particular for analyzing a cyclical or noncyclical sequential process, which typically includes multiple subprocesses.

### Description of the Background Art

If users would like to optimize a sequential process, such as a production process and/or a logistics process, for example by employing artificial intelligence, the first hurdle lies in accessing the control unit which controls or regulates the sequence of the sequential process. The focus is often on already existing machines and/or installations, in which the access to the control unit, in particular the program logic, is reserved for the manufacturer or the supplier of the machine/installation. Obtaining independent access to the control unit is usually associated with additional costs or with considerable effort for the user-if this is even possible at all.

Previously known methods, such as the method known from EP 2 946 568 A1, for monitoring electronic and/or electrical equipment use power parameters measured/monitored via a main power cable for the purpose of ascertaining and reducing the energy demand of a piece of equipment. A so-called NILM (non-intrusive load monitoring) method is also known. The NILM method is based on the assumption that each piece of technical equipment of an installation generates an individual signal. These signals are detected as aggregated overall power consumption of the installation. With the aid of pattern recognition algorithms (NILM algorithms) and machine learning methods, individual equipment signals within the overall power consumption are broken down, i.e., disaggregated. Due to the disaggregation, the energy consumption of individual pieces of equipment may be ascertained and used for the energy optimization of the system.

These previously known methods are aimed at the energy optimization of equipment and do not make it possible to obtain general process data relating to the setpoint and actual sequential process. In particular, these previously known methods do not make it possible to analyze process data of a cyclical or noncyclical sequential process so as to divide the sequential process into repeating subprocesses in an automated manner in order to subsequently be able to rate the process stability and/or process quality with regard to the individual subprocesses of the sequential process.

### SUMMARY OF THE INVENTION

It is therefore an object of the present invention to ascertain and analyze process data of a sequential process, in particular its time sequences and states, for the purpose of obtaining process data relating to the setpoint and actual sequential process without having access to the actual control unit which controls/regulates the sequential process.

In particular, an object of the present invention is to divide a cyclical or noncyclical sequential process into repeating subprocesses, based on ascertained process data, for the purpose of being able to subsequently rate the process stability with regard to the individual subprocesses of the sequential process.

This object is achieved in an exemplary embodiment, by a method for analyzing a sequential process, the sequential process including at least one repeating subprocess. The method includes at least the steps: Recording process data of the sequential process over a reference time period; Automatically determining phase limits, based on the recorded process data; Identifying at least one repeating subprocess, the duration of which is limited in time by two adjacent phase limits; Determining at least one reference variable for each identified repeating subprocess from the process data recorded in the time period; Recording process data of the sequential process over a time period following the reference time period, and repeating the steps of determining and identifying for the purpose of detecting the recurrence of an identified subprocess; and Comparing the recorded process data of the detected subprocess with the at least one reference variable of the corresponding identified subprocess for the purpose of establishing deviations from a normal operation.

A sequential process to be analyzed may be a cyclical or noncyclical sequential process. However, the sequential process to be analyzed includes at least one repeating subprocess. The method makes it possible to automatically divide this sequential process into subprocesses, the duration of a subprocess being limited in time by two adjacent phase limits. The automated division of the sequential process into subprocesses comprises the method steps b. (automatically determining phase limits) and c. (identifying the repeating subprocess). The sequential process to be analyzed may include repeating subprocesses as well as non-repeating subprocesses, a repeating subprocess being able to occur repeatedly during the execution time of the sequential process. A repeating process may likewise occur only once during the execution time of the sequential process.

A sequential process to be analyzed may be, for example, a sequential process in production or logistics. The subprocesses reflect different process steps. One example of a sequential process in production is a repeating task which is carried out by a robot. The sequential process may comprise, for example, the following three subprocesses: Grasp component, change position, release component. A further example of a sequential process is an injection molding process, including the subprocesses: Close mold, inject, hold pressure, plasticize, open mold. An example of a noncyclical sequential process comprises the subprocesses: Machine on, machine off, standby. A further example of a noncyclical sequential process comprises the subprocesses: room occupied, room unoccupied, room occupied by multiple visitors. The individual subprocesses are separated from each other by phase limits in each case.

Based on the identified subprocesses, at least one reference variable may be determined, for example by averaging the corresponding process data which were recorded during the reference time period. The process data as well as the reference variable(s) may each be variables that change over time or a set of variables that change over time. The process data and the reference variable(s) may be recorded and displayed, for example by temporal curve profiles. In particular, the reference variable may comprise a lower and/or upper threshold value, which define(s) the limits of the normal operation of the particular subprocess.

The reference time period may be freely selected. In the case of noncyclical sequential processes, the reference time period may continue to be selected, for example, until at least one repeating subprocess has been detected. In the case of cyclical sequential processes, the reference time period may be selected to be, for example, at least equal to the periodic time of the sequential process.

The recurrence of an identified subprocess may be detected by recording process data of the sequential process over a time period following the reference time period, and repeating steps b. and c. The time period following the reference time period does not have to immediately follow the reference time period, but may begin at an arbitrary later point in time.

After a repeating subprocess has been detected, the corresponding recording process data may be compared with the at least one reference variable of the corresponding identified subprocess. This makes it possible to establish and classify deviations from a normal operation. A measure of the stability and/or quality of a subprocess and/or at last one portion of the subprocess may thus be determined.

In particular, the method makes it possible to detect a change and/or a type of the change of a repeating subprocess. Because the determination of phase limits must be carried out separately for each sequential process, this step is carried out in an automated manner. The invention may facilitate a phase limit determination, which corresponds as closely as possible to a phase limit determination following an optical sensing of graphically displayed process data (curve profiles). As a result, the user of the sequential process does not have to manually carry out the determination of the phase limits or the identification and detection of repeating subprocesses.

For example, the phase limit determination may take place within an execution time T. Individual features or their combination of the recorded process data may be analyzed for this purpose. This initially requires the determination of phase limits. Phase limits separate phases of a similar feature configuration (i.e. subprocesses) from each other. The goal of determining the phase limits is to achieve a preferably similar division of the sequential process, which would also be the result of a manual division, based on an optical analysis of the graphically displayed process data.

A cycle of a cyclical sequential process or a noncyclical sequential process may be described by Y=Y_{0 . . . T}. Y may b a one- or multi-dimensional signal (process data), e.g. the power consumption or the vibration of a machine. T is the periodic time of the repeating cycle or the execution time of the noncyclical sequential process.

Sequential process Y may be initially divided into K phases (subprocesses), which are separated by phase limits: tₖ∈[0, T], k∈{0, . . . , K}. The individual phases may then be described by yₜ_{ₖ}_{. . . t}_{ₖ₊₁}·t_{K}≙t₀+T applies to cyclical processes; t₀=0 and t_{K}=T apply to noncyclical processes. For example, the change point detection method is suitable for determining the phase limits. The costs cₘ(yₜ_{ₖ}_{. . . t}_{ₖ₊₁}) may be calculated for each phase and added up to total costs

$${V}_{K , m} ( {t}_{k} , Y ) := \{ \begin{matrix}{\sum }_{k = 0}^{K - 1} {c}_{m} ( {y}_{{t}_{k} … {t}_{k + 1}} ) & K > 0 \\ {c}_{m} ( {Y}_{0 … T} ) & K = 0\end{matrix}$$

The cost functions cₘ(yₜ_{ₖ}_{. . . t}_{ₖ₊₁}) detect a measured variable, such as the deviation from the mean value, changes in the variance or deviations from a linear behavior within a phase Yₜ_{ₖ}_{. . . t}_{ₖ₊₁}. Different cost function models m detect different measured variables. Different phase limits are “proposed” by the use of search methods. Phase limits tₖ are ascertained by minimizing the total costs:

$${min}_{{t}_{k}} {V}_{K , m} ( {t}_{k} , Y ) .$$

After the phase limits have been determined, the actual analysis of the sequential process over a longer period of time t>>T may be started. In particular, the subprocess currently being executed may be displayed, and subprocesses may be highlighted, which deviate from normal operation. This gives the user of the sequential process a starting point for the deeper analysis of the sequential process. In particular, the subprocess with the greatest deviation from normal operation may be, for example, a observation focal point of a subsequent analysis for the purpose of optimizing the process stability and/or process quality. Moreover, the dependencies between OK/NOK parts, which were processed/manufactured during the sequential process, may be evaluated and corresponding subprocesses used for an error analysis.

The determination of the phase limits by means of change point detection methods typically requires knowledge of the number of phases/subprocesses of the sequential process as well as knowledge of which combination of search method and cost function is suitable for describing the sequential process. For example, if different constant values are assumed in the sequential process, a cost function which measures the deviation from the mean value is suitable for describing the sequential process. If the number of phases/subprocesses of the sequential process is unknown, the number of phases/subprocesses of the sequential process may be determined in an automated manner.

In particular, the sequential process may be a cyclical sequential process, and the reference time period may comprise at least one, preferably at least two, periodic times T of the cyclical sequential process. In particular, the method may comprise the automated determination of the periodic time as an additional step. The reference variable may be ascertained more precisely as the length of the reference time period increases, so that more reliable statements may be made about the stability and quality of a subprocess and/or at least one portion of the sequential process. The automated determination of the periodic time makes it possible to analyze cyclical sequential processes having an initially unknown periodic time. Cyclical sequential processes facilitate a particularly accurate monitoring of the process stability, since a unique reference variable, for example in the form of a reference period, exists due to the periodic process data (such as the power consumption). Deviations from this reference variable are measurable and provide information about changes in the sequential process or changes in corresponding subprocesses.

The method may furthermore comprise the automated determination of the number of repeating subprocesses during a periodic time or an execution time of the sequential process. Sequential processes may thus be analyzed, whose number of subprocesses is unknown prior to the start of the analysis.

In particular, the automated determination of the number of repeating subprocesses may comprise at least the calculation of a difference between a reference distribution and a normalized gain value and/or the evaluation of at least one cost function.

To automatically determine a reasonable number of phases (subprocesses) in the sequential process, a normalized gain gain_{K}^{norm} may initially be calculated. This normalized gain describes the absolute value by which the total costs are reduced by adding a further phase:

$$g a i {n}_{K , m}^{n o r m} : = \{ \begin{matrix}\frac{{V}_{K - 1 , m} - {V}_{K , m}}{{V}_{0 , m}} & ∀ K > 2 \\ \frac{{V}_{0 , m} - {V}_{2 , m}}{{V}_{0 , m}} & f ü r K = 2 \\ 1 & f ü r K = 0 ⩔ K = 1\end{matrix}$$

It should be noted that the gain has meaning only for K≥2 phases. gain_{K,m}^{norm}∈[0; 1] also applies, since V_{K,m} is (strictly) monotonous. This approach is based on the assumption that the gain converges toward zero as the number of phases K increases, and a specific point K₀ exists, at which the profile of the gain curve abruptly flattens out (cf. FIG. 6). To find this point K₀, a reference distribution of the form

$$r e {f}_{K} := {e}^{- \frac{1}{s} {K}^{2}}$$

may be defined, which does not have an abrupt change of this type. The parameter s permits a stretching of the reference function and is thus a measure of the sensitivity. A so-called gap gap_{K} describes the difference between the reference distribution and the gain:

gap_{K,m}:=ref_{K}−gain_{K,m}^{norm}.

The maximum gap indicates the optimal number of phases, i.e., the subprocesses of the sequential process. In other words, the maximum gap occurs at the point where, for the first time, it no longer pays off to insert an additional phase:

$${K}_{o p t} = ( {argmax}_{K} {gap}_{K , m} ) - 1.$$

Likewise, a characteristic value for the quality q_{cr} (“Cr” for cost reduction) of the cost reduction may be determined for the automated determination of the number of repeating subprocesses. A phase division [symbol] is described by a quantity of phase limits [symbol] ={t₀, . . . , t_{K}} and may be ascertained, for example, as illustrated above. The normalized costs

$$\frac{{\sum }_{k = 0}^{K - 1} {c}_{m} ( {y}_{{t}_{k} … {t}_{k + 1}} )}{{c}_{m} ( {Y}_{0 … T} )}$$

may be calculated for a phase division. To achieve comparability, this value may be averaged across all cost functions observed. In the following, M is the quantity of all cost function models observed, and #M is their potency:

$${q}_{cr} ( 𝒯 , Y , M ) = \frac{1}{\# M} {\sum }_{m ∈ M} \frac{{\sum }_{k = 0}^{K - 1} {c}_{m} ( {y}_{{t}_{k} … {t}_{k + 1}} )}{{c}_{m} ( {Y}_{0 … T} )} .$$

This value may be interpreted as the share to which the total costs of a process Y are reduced on average by a phase division [symbol] , i.e., in relation to a quantity of cost functions. The phase division [symbol] having the lowest value for q_{cr} may be viewed as the best possible phase division. For example, the phase divisions of different combinations of cost functions and search method may thus be compared. This permits the automated selection of cost functions and search methods or the automated combination of cost functions and search methods for the purpose of analyzing sequential processes.

The characteristic value for the quality q_{cr} may also be interpreted as the cost function

$${c}_{a v g} ( {Y}_{{t}_{k} … {t}_{k + 1}} ) = \frac{1}{\# M} {\sum }_{m ∈ M ∖ \{ a v g \}} \frac{{c}_{m} ( {y}_{{t}_{k} … {t}_{k + 1}} )}{{c}_{m} ( {Y}_{0 … T} )}$$

averaged across all models, which is added up across all K phases.

A generic cost function model “gen” may also be used as an alternative cost function, which combines different cost functions, in that the normalized costs for a phase are minimized:

$${c}_{g e n} ( {Y}_{{t}_{k} … {t}_{k + 1}} ) = {min}_{m ∈ M ∖ \{ g e n \}} \frac{{c}_{m} ( {y}_{{t}_{k} … {t}_{k + 1}} )}{{c}_{m} ( {Y}_{0 … T} )} .$$

This alternative does not involve an automatic selection of a search method, but may be combined with the variant described above of calculating the quality q_{cr}.

The selection of a cost function and a search method or the combination thereof may thus be automated. Likewise, different cost function models may be used to determine the phase limits or divide the phases within a sequential process.

In particular, a control program of the sequential process and/or exact process phases of the sequential process may be unknown at the start of the analysis of the sequential process for a device which is configured to analyze the sequential process. This facilitates the automated analysis of sequential processes.

The process data may be sensor data, in particular aggregate signals of sensor signals, in particular preferably exclusively total power consumption data of the sequential process and/or vibration data of an industrial plant. The use of process data such as aggregate signals, total power consumption data, vibration data and/or the like makes it possible to analyze sequential processes without explicitly having access to the actual control unit which controls/regulates the sequential process.

The process data may, for example, describe the energy balance of a machine/installation, whose sequential process is to be analyzed. Fed-in electrical energy is converted into other energy forms during the operation of the machine/installation. If an actuator moves or if a sensor is used, electrical energy is applied for this purpose. For example, the sequential process, including its subprocesses, may therefore be described with the aid of the total power consumption data and analyzed on this basis. It is not necessary to record and evaluate individual sensor signals for the purpose of the analysis. Instead, it is sufficient to record/evaluate an aggregate signal. Sequential processes may thus be analyzed, for which only aggregate signals are available. The recording of these aggregate signals, such as the total power consumption data, vibration data and/or the like, is easy to achieve and may be carried out cost-effectively.

In particular, different search methods and cost functions may be used to automatically determine phase limits of a sequential process and to identify at least one repeating subprocess of the sequential process. This facilitates a precise description of the sequential process and a preferably exact determination of the phase limits.

The step of automatically determining phase limits may be carried out with the aid of change point detection methods. As described above, the determination of phase limits with the aid of change point detection methods facilitates an exact automatic determination of phase limits between subprocesses.

The reference variables of a subprocess may include at least one of the following variables: mean value, standard deviation, variance. In addition, the reference variable may have an upper and/or lower threshold value, the reference variable as well as the threshold values being able to characterize the normal operation. The mean value, standard deviation and variance may be easily determined. In addition, the recorded process data of a detected subprocess may be easily compared with these reference variables of the corresponding identified subprocess for the purpose of establishing deviations from a normal operation. In addition, the determination of a reference variable makes it possible to eliminate and/or reduce disturbance variables. This may take place, for example, by means of averaging. The reference variable ascertained in this manner may be stored, for example, as an ideal reference period for later comparison with further process data/comparison variables.

In particular, the identification of at least one repeating subprocess may comprise the identification of similar curve profiles of the process data, similar curve profiles preferably having a certain sequence of positive and/or negative increases within predetermined tolerance ranges. Corresponding subprocesses may thus be quickly and reliably identified.

The method may furthermore comprise the determination of at least one comparison variable for the detected subprocess, the comparison comprising a comparison of the at least one comparison variable with the at least one reference variable. The determination of a comparison value facilitates a simplified assessment of the process stability and/or process quality, since the comparison variable of the detected subprocess may be directly compared with the reference variable of the corresponding subprocess. The deviation of the comparison variable and reference variable may be used as a measure of the stability and/or quality of the subprocess or sequential process.

The comparison may involve a comparison of the value of the at least one comparison variable at the present point in time with a value of the corresponding reference variable at an earlier point in time. The comparison variable of a subprocess may include at least one of the following variables: mean value, standard deviation, variance. Additionally or alternatively, the comparison may involve a comparison of the value of the at least one comparison variable of the detected subprocess with the value of this comparison variable of a further corresponding subprocess during the same period of the sequential process. The comparison of the comparison variable with the value of the corresponding reference variable facilitates an assessment of the stability and/or quality of the subprocess or sequential process in comparison with a reference sequential process. This corresponds to a setpoint and actual sequential process comparison. The comparison of the value of the at least one comparison variable of the detected subprocess with the value of this comparison variable of a further corresponding subprocess during the same period of the sequential process makes it possible to assess the stability and quality of the sequential process during the execution of the sequential process. Deviations from the normal operation may thus be quickly detected.

The normal operation may be determined by the reference variable and optionally by a predetermined tolerance range of the reference variable for each identified subprocess. The tolerance range of the reference variable may be determined, in particular, by an upper and lower threshold value. If the recorded process data or the comparison value of a detected subprocess are outside the tolerance range, a deviation from the normal operation may be concluded. This deviation may be communicated to the user of the sequential process.

In particular, the results of the comparison may be displayed to the user of the sequential process on a user interface, such as a graphical user interface. The results of the comparison or a signal, which indicates the deviation, may furthermore be forwarded to another controller, such as the control unit of the sequential process, for the purpose of, for example, stopping the sequential process or switching to an error mode.

The method may also comprise the rating of the process stability of the sequential process and/or at least one subprocess, based on an ascertained deviation from the normal operation. The process stability may be rated, for example, on a scale of 0 to 1. Value 1 corresponds in this case to a setpoint process stability, which was initially determined, for example, during the receipt of the process data within reference time period T_{ref}. If a deviation from the normal operation is established, for example by comparing the comparison variable with the corresponding reference variable, the process stability may be rated with a value less than 1 for the corresponding subprocess to be rated. If the process stability of the sequential process and/or the subprocess drops below a predefined lower threshold value, for example the sequential process and/or the subprocess may be stopped, a warning issued and/or a warning interval adapted.

The method may furthermore comprise the identification of the type of deviation from the normal operation. The type of deviation may take place in an automated manner. In particular, the type of deviation from the normal operation may be identified by evaluating the time characteristic of the process stability of the sequential process and/or at least one subprocess. For this purpose, the rated process stability is stored for the pass after each detection of a subprocess. The time characteristic of the process stability may then be displayed graphically so as to be able to quickly and easily identify the type of deviation from normal operation.

For example, the following types of deviations may be identified: Shift, drift, noise and/or other anomalies. The type of deviation may be identified by evaluating the process data, the comparison variable and/or the process stability. Error cases of the sequential process and/or the machine may be assigned to these deviation types, depending on the subprocess, such as the failure of a part of the machine, the wear of a part of the machine or the collision of a part of the machine. In particular, the evaluation of the time characteristic of the process stability for identifying the type of deviation from the normal operation makes it possible to quickly and easily identify the deviation type even over a longer observation period.

The object is also achieved by a device for analyzing a sequential process, the device comprising at least one sensor arrangement for recording process data of the sequential process. The device is configured to carry out the method described above. The device may, in particular, be different from the machine/installation which carries out the sequential process to be analyzed. This makes it possible to analyze sequential processes in existing systems, such as machines or installations, by retrofitting the device.

The sensor arrangement may comprise a current sensor, a power consumption sensor and/or a vibration sensor. Other sensor are also possible. In particular, the sensor arrangement may be configured to record at least one aggregate signal of the sequential process to be analyzed.

The device may furthermore comprise a graphical user interface, which is configured to display process data, a reference variable and/or a comparison variable, the graphical user interface being able to be configured, in particular, so that a user of the sequential process is able to (manually) label displayed phase limits and/or displayed process data of a subprocess. A specific sequence of the sequential process may be assigned hereby to the recorded process data of a subprocess, for example grasp component, change position, release component, and the assessment of the process stability and/or process quality may thus be simplified.

The object is also achieved by a computer program, comprising program instructions, which may be executed by at least one processor, and which prompt the processor to control a device according to a method described above.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic representation of a device for analyzing a sequential process;

FIG. 2 shows a schematic sequence of a method for analyzing a sequential process;

FIG. 3 shows an exemplary representation of process data of a sequential process;

FIG. 4 shows an exemplary representation of process data of a further sequential process;

FIGS. 5a to 5C show an exemplary representation of process data of a further sequential process;

FIG. 6 shows an example of a normalized gain function; and

FIGS. 7A to 7D show an exemplary representation of deviations from the normal operation.

### DETAILED DESCRIPTION

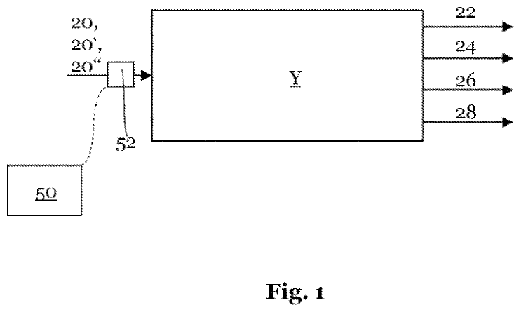

FIG. 1 shows a schematic representation of a device 50 for analyzing a cyclical or noncyclical sequential process Y. An example of a cyclical sequential process Y is a repeating task, which is carried out by a robot. Sequential process Y may comprise, for example, the following three subprocesses y_{t,k . . . t,k+1}: grasp component y_{t,o . . . t,1}, change position y_{t,1 . . . t,2}, release component y_{t,2 . . . t,o+T}. A further example of a sequential process Y is an injection molding process, including the following five subprocesses y_{t,k . . . t,k+1}: close mold y_{t,o . . . t,1}, inject y_{t,1 . . . t,2}, hold pressure y_{t,2 . . . t,3}, plasticize y_{t,3 . . . t,4}, open mold y_{t,4 . . . t,o+T}. Individual subprocesses y_{t,k . . . t,k+1} are separated from each other in each case by phase limits t₀ . . . tₖ. An example of a noncyclical sequential process T comprises subprocesses y_{t,k . . . t,k+1} of machine on, machine off, standby. A further example of a noncyclical sequential process Y comprises subprocesses y_{t,k . . . t,k+1} of room occupied, room unoccupied, room occupied by multiple visitors.

Device 50 may record process data 20, 20′, 20″ for the purpose of analyzing sequential process Y. In particular, device 50 may comprise a sensor arrangement 52 for recording process data 20, 20′, 20″ of the sequential process. Process data 20, 20′, 20″ may be an overall input variable (aggregate signal), for example the total power consumption. Process data 20, 20′, 20″ may also be another aggregate signal, such as vibration data of an industrial plant, temperature data, noise emission data or the like. Correspondingly, sensor arrangement 52 may comprise at least one current sensor, a power consumption sensor, a vibration sensor, a temperature sensor, a noise emission sensor and/or other process data sensors.

Individual output variables 22, 24, 26, 28 of sequential process Y (e.g., component-specific power consumption, component-specific vibration data, component-specific temperature data, component-specific noise emission data, location data of individual components, or the like) may be inaccessible to the user of sequential process Y and/or to device 50 and thus not be available for analyzing sequential process Y. To nevertheless be able to analyze sequential process Y, process data 20, 20′, 20″ may be recorded and analyzed according to method 100 for analyzing a sequential process.

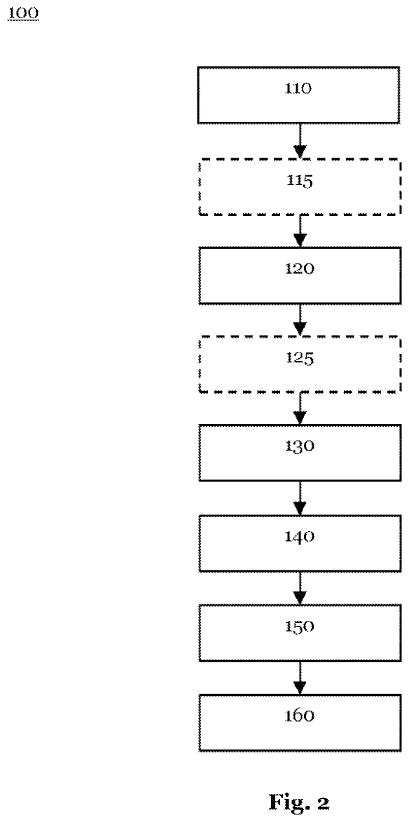

FIG. 2 shows a schematic representation of a method 100 for analyzing a sequential process; The method comprises the steps of (a.) recording 110 process data, optionally automatically determining 115 the periodic time of the sequential process; (b.) determining 120 phase limits, optionally automatically determining 125 the number of repeating subprocesses; (c.) identifying 130 a repeating subprocess; (d.) determining 140 a reference variable; (e.) recording 150 process data; and (f.) comparing 160 the recorded process data for the purpose of establishing deviations from a normal operation. Sequential process Y may thus be analyzed by observing process data 20, 20′, 20′—even without knowledge of output variables 22, 24, 26, 28.

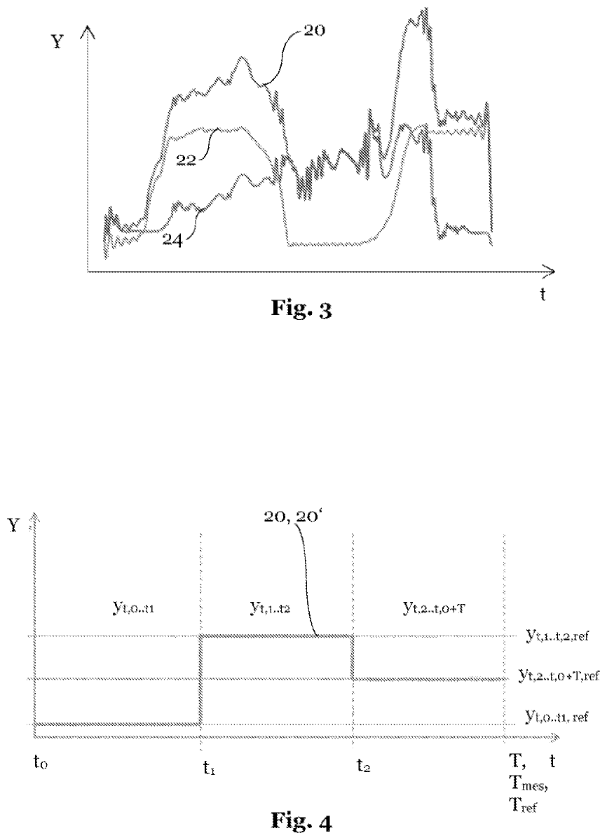

FIG. 3 shows an exemplary representation of process data 20 of a sequential process Y, which were recorded during a time period T_{ref} (reference time period) and/or a time period Tₘₑₛ (measurement time period). FIG. 3 also shows output variables 22 and 24, which represent, for example, the power consumption of individual components—such as individual actuators—of an industrial plant over the course of time. According to the method, process data 20 are recorded, which represent, for example, the time characteristic of the total power consumption of the industrial plant. Output variables 22 and 24, which each represent, for example, the time characteristic of a component-specific power consumption of a component of the industrial plant, are not recorded and are thus not available for the analysis of sequential process Y. Based on process data 20 recorded during reference time period T_{ref}, phase limits are automatically determined and repeating subprocesses identified. At least one reference variable is furthermore determined for each identified repeating subprocess. Correspondingly, further process data may be recorded during a measurement time period Tₘₑₛ, which follows reference time period T_{ref}. These process data as well would represent the time characteristic of the total power consumption of the industrial plant in the above example. The recurrence of an identified subprocess is detected according to the method. The process data recorded during measurement time period Tₘₑₛ may then be compared with a previously determined reference variable of the corresponding identified subprocess for the purpose of establishing deviations from a normal operation.

In particular, the recorded process data may be aggregate signals, for example total power consumption data of the sequential process. The use of aggregate signals makes it possible to analyze sequential processes without explicitly having access to output variables 22, 24, which represent, for example, the time characteristic of a component-specific power consumption of a component of the industrial plant.

FIG. 4 shows an exemplary representation of process data 20, 20′ of a further sequential process Y. This exemplary representation is intended to illustrate the automatic determination of the phase limits as an example, based on the change point detection method. For this purpose, recorded process data 20, 20′ (signal) are divided into phases (i.e., subprocesses yₜ_{ₖ}_{. . . t}_{ₖ₊₁}). The phase limits are described by t₀ . . . t₃. To determine the phase limits, the sum of all costs c(yₜ_{₀}_{. . . t}_{₂}) of the signal profile

$$V ( t ; y ) = {\sum }_{k = 0}^{3} ( c ( {y}_{{t}_{k} … {t}_{k + 1}} ) )$$

must be minimized by varying the phase limits tₖ. The cost functions measure, for example, the deviation of the signal with respect to its mean value (in this case, y_{0, ref}, y_{1,ref}, y_{2, ref}) between two adjacent phase limits. Cost functions for further features or the combination thereof may also be used. The phase limits are derived by minimizing the function V(t; y). A signal is shown in FIG. 4, which represents process data 20 which were recorded during a reference time period T_{ref}. Likewise, the illustrated signal may represent process data 20′ which were recorded during a measurement time period Tₘₑₛ. Illustrated signal 20, 20′ assumes three values in the illustrated example in FIG. 4. If the cost functions measure the deviations with respect to the mean value between two adjacent phase limits, a minimum of the function V(t; y) is assumed if the limits tₖ are selected in such a way that they are situated exactly at the points in time, at which the signal changes its value. This is the case between t₀ and t₁ for y_{t,0 . . . t,1,ref}, between t₁ and t₂ for y_{t,1 . . . t,2,ref}, and between t₂ and T (or. t₃) for y_{t,2 . . . t,0+T,ref}. The automatically determined phase limits are thus t₀, t₁, and t₂.

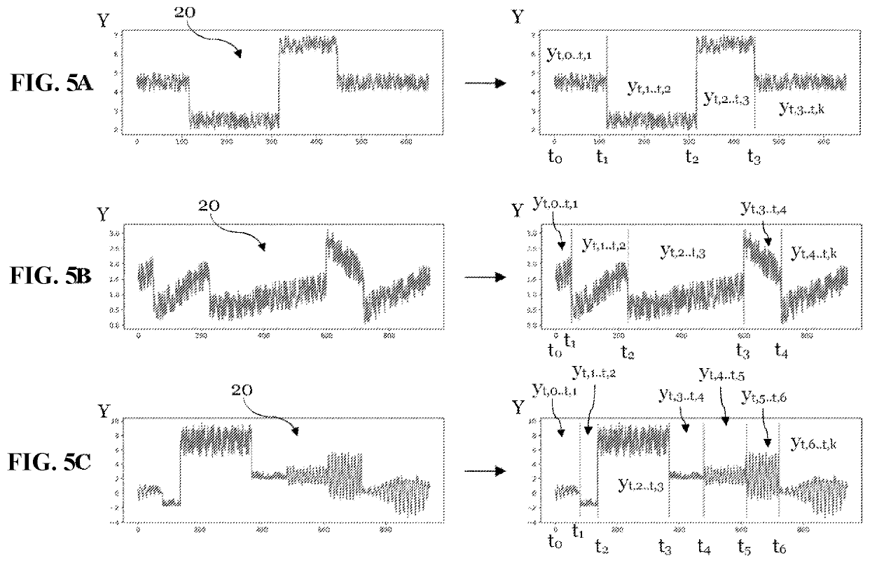

FIGS. 5a through 5C each show an exemplary representation of process data 20 of a further sequential process Y. Process data 20 may represent, for example, the profile of the total power consumption of an industrial plant over time during sequential process Y. The raw signal of the recorded process data is shown on the left in each case. The process data after the analysis according to method steps (b.) and (c.) are shown on the right, i.e., after automatic determination 120 of phase limits t₀, . . . , tₖ and identification 130 of at least one repeating subprocess y_{t,k . . . t,k+1}. The particular (raw) signals are noisy signals, FIG. 5A showing a signal having abrupt changes of the mean value, FIG. 5B showing a jagged signal, and FIG. 5C showing a mixed signal. These signals are suitable as input data (process data) for analyzing the sequential process.

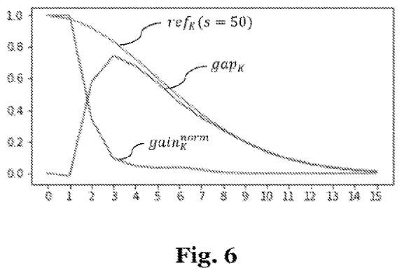

FIG. 6 shows an example of the calculation of a difference between a reference distribution and a normalized gain value gain_{K}^{norm}, as described above, this calculation underlying the automated determination of the number of repeating subprocesses.

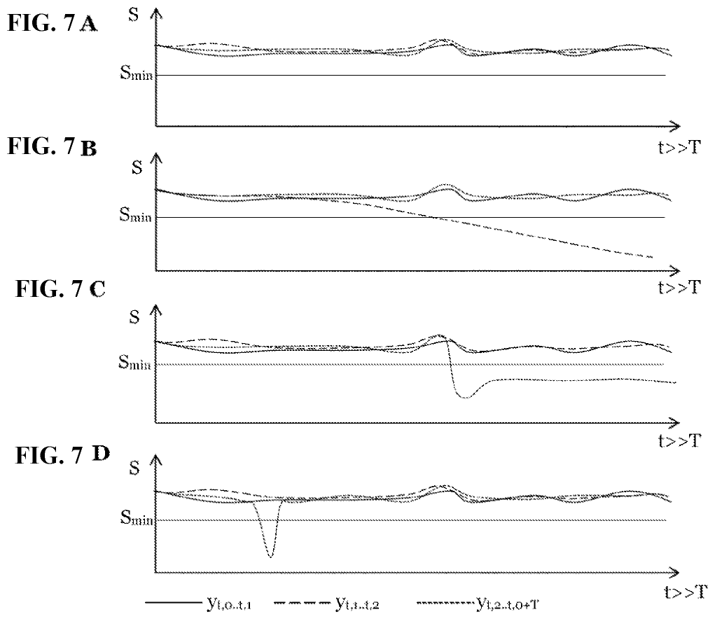

FIGS. 7A through 7D each show an exemplary representation of a time characteristic of the process stability S for subprocesses y_{t,0 . . . t,1}, y_{t,1 . . . t,2}, y_{t,2 . . . t,0+T}. The process stability may be rated, for example, on a scale of 0 to 1. Value 1 corresponds in this case to a setpoint process stability, which was initially determined, for example, during the recording of the process data within reference time period T_{ref}. If a deviation from the normal operation is established, for example by comparing the comparison variable with the corresponding reference variable, the process stability may be rated with a value less than 1 for the corresponding subprocess to be rated.

The time characteristics of process stability S shown in FIGS. 7A through 7D for subprocesses y_{t,0 . . . t,1}, y_{t,1 . . . t,2}, y_{t,2 . . . t,0+T} are recorded over a long time period t>>T. Each point of a time characteristic represents the process stability of a corresponding subprocess y_{t,0 . . . t,1}, y_{t,1 . . . t,2}, y_{t,2 . . . t,0+T}, as rated after the execution (and detection) of the particular subprocess.

A lower threshold value Sₘᵢₙ of process stability S is also plotted in FIGS. 7A through 7D. If process stability S is rated as greater than Sₘᵢₙ after the execution (and detection) of the particular subprocess, no deviation or a tolerable deviation from the normal operation is present. If process stability S of the sequential process and/or the subprocess drops below predefined lower threshold value Sₘᵢₙ, for example the sequential process and/or the subprocess may be stopped, a warning issued and/or a warning interval adapted.

In FIG. 7A, process stability S is above lower threshold value Sₘᵢₙ for all subprocesses y_{t,0 . . . t,1}, y_{t,1 . . . t,2}, y_{t,2 . . . t,0+T}. Consequently, none of subprocesses y_{t,0 . . . t,1}, y_{t,1 . . . t,2}, y_{t,2 . . . t,0+T} deviates from the normal operation, and a tolerable deviation from the normal operation is present in each case. The (sub)process quality and (sub)process stability may be rated as good.

In FIG. 7B, process stability S deviates from the normal operation for subprocess y_{t,1 . . . t,2}, i.e., process stability S is at least partially below threshold value Sₘᵢₙ. In particular, process stability S decreases for subprocess y_{t,1 . . . t,2} as observation time t progresses. The type of deviation (in this case: drift) may be classified and output to the user. The occurrence of a deviation of the “drift” type may, for example, point to the wear of a component, which is in operation during subprocess y_{t,1 . . . t,2}.

Process stability S also deviates from the normal operation for subprocess y_{t,2 . . . t,0+T} in FIG. 7C. In this case, a slow drifting of the process stability S does not occur (as in FIG. 7B), but instead a sudden change occurs. The type of deviation (in this case: shift) may be classified and output to the user. The occurrence of a deviation of the “shift” type may, for example, point to a sudden damage to a component, which is in operation during subprocess y_{t,2 . . . t,0+T}.

An example of a fourth case is shown in FIG. 7D. In this case, an “anomaly” occurs in the rating of process stability S for subprocess y_{t,2 . . . t,0+T}. The type of deviation (in this case: anomaly) may be classified and output to the user. The occurrence of a deviation of the “anomaly” type may, for example, point to an sequential process or subprocess which was not optimally set. For example, participating components collide or “get stuck”. Likewise, a deviation of the “anomaly” type may point to an imminent failure of a component.

A detected deviation and/or the type of detected deviation is/are typically output to the user of the sequential process. The latter may then interpret the process data, the comparison variable and/or the process stability, in particular the time characteristic of the process stability to draw conclusions as to the deviation from the normal operation, the type of deviation from the normal operation and/or the cause of the deviation from the normal operation for the entire sequential process and/or individual subprocesses.

The assessment of the (sub)process quality and stability may be simplified by the present invention. This may take place separately for each subprocess and/or for the entire sequential process. In particular, no raw sensor data need to be interpreted for assessing the (sub)process quality.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method to analyze a sequential process, the sequential process comprising at least one repeating subprocess, the method comprising:
recording process data of the sequential process over a reference time period;
automatically determining phase limits based on the recorded process data;
identifying at least one repeating subprocess, a duration of which is limited in time by two adjacent phase limits;
determining at least one reference variable for each identified repeating subprocess from the process data recording in the time period;
recording process data of the sequential process over a time period following the reference time period;
repeating the steps of automatically determining and identifying to detect the recurrence of an identified subprocess; and
comparing the recorded process data of the detected subprocess with the at least one reference variable of the corresponding identified subprocess to establish deviations from a normal operation.

2. The method according to claim 1, wherein the sequential process is a cyclical sequential process, and the reference time period comprises at least one, preferably at least two, periodic times of the cyclical sequential process, and wherein the method further comprises automatically determining the periodic time.

3. The method according to claim 1, wherein the method further comprises automatically determining the number of repeating subprocesses during a periodic time or an execution time of the sequential process.

4. The method according to claim 3, wherein the automated determination of the number of repeating subprocesses comprises at least the calculation of a difference between a reference distribution and a normalized gain value and/or the evaluation of at least one cost function.

5. The method according to claim 1, wherein a control program of the sequential process and/or exact process phases of the sequential process are unknown at the start of the analysis of the sequential process for a device, which is configured to analyze the sequential process.

6. The method according to claim 1, wherein the process data are sensor data or aggregate signals of sensor signals or exclusively total power consumption data of the sequential process and/or vibration data of an industrial plant.

7. The method according to claim 1, wherein different search methods and cost functions are used to automatically determine phase limits of a sequential process and to identify at least one repeating subprocess of the sequential process.

8. The method according to claim 1, wherein the step of automatically determining phase limits is carried out with the aid of change point detection methods.

9. The method according to claim 1, wherein the at least one reference variable of a subprocess includes: mean value, standard deviation, and/or variance.

10. The method according to claim 1, wherein the identification of at least one repeating subprocess comprises the identification of similar curve profiles of the process data, similar curve profiles preferably having a certain sequence of positive and/or negative increases within predetermined tolerance ranges.

11. The method according to claim 1, wherein the method further comprises determining at least one comparison variable for the detected subprocess, and the comparison comprising a comparison of the at least one comparison variable of the detected subprocess with the at least one reference variable of a corresponding subprocess, and the comparison variable of a subprocess being able to include at least: mean value, standard deviation, and/or variance.

12. The method according to claim 1, wherein the comparison involves a comparison of the value of the at least one comparison variable at the present point in time with a value of the corresponding reference variable at an earlier point in time, and/or a comparison of the value of the at least one comparison variable of the detected subprocess with the value of this comparison variable of a further corresponding subprocess during the same period of the sequential process.

13. The method according to claim 1, wherein the normal operation is determined by the reference variable and a predetermined tolerance range of the reference variable for each identified subprocess.

14. The method according to claim 1, further comprising: rating the process stability of the sequential process and/or at least one subprocess, based on an ascertainment of a deviation from normal operation.

15. The method according to claim 1, further comprising: displaying the results of the comparison on a user interface and/or forwarding these results to a further controller.

16. The method according to claim 1, further comprising: identifying the type of deviation from normal operation.

17. A device to analyze a sequential process, the device comprising:
at least one sensor arrangement for recording process data of the sequential process,
wherein the device is configured to carry out the method according to claim 1.

18. The device according to claim 17, wherein the sensor arrangement comprises a current sensor, a power consumption sensor and/or a vibration sensor.

19. A computer program, comprising program instructions, which are carried out by at least one processor and prompt the processor to control a device according to the method according to claim 1.
